(19) United States
(12) Patent Application Publication
(10) Pub. No.: US 2026/0145195 A1
(43) Pub. Date: May 28, 2026

(54) SYSTEM AND METHOD FOR A SPRING MASKING DEVICE FOR PAINTING

(71) Applicant: PPG Industries Ohio, Inc., Cleveland, OH (US)

(72) Inventors: Roger Gerard Siefker, Jr., Ottawa, OH (US); Brent Allen Schwartz, Oak Ridge, TN (US)

(73) Assignee: PPG Industries Ohio, Inc., Cleveland, OH (US)

(21) Appl. No.: 19/127,218

(22) PCT Filed: Nov. 10, 2022
(86) PCT No.: PCT/US2022/079670

§ 371 Date: May 5, 2025

(51) Int. Cl. B05B 12/26

(52) U.S. Cl. CPC B05B 12/26

(57) ABSTRACT

Disclosed herein is a spring device (10) for paint masking a component including a top plate (110) opposite a bottom plate (130), wherein the top plate is secured to the bottom plate by a securing rod (180), an intermediate plate (150) located between the top plate and the bottom plate, and a spring in contact with the intermediate plate and the top plate.

### FIELD

The present disclosure relates to a spring device for paint masking.

### BACKGROUND

The use of paint masking devices during painting operations may often be utilized to prevent certain portions of components from being painted. For axle housings, paint masking devices may be used to prevent paint from entering an inside surface of the axle housing. Paint masking devices may provide leak tight seals to prevent leakage of paint.

### SUMMARY

Disclosed herein is a paint masking system including an axle housing structured and arranged to surround an axle of a vehicle. The axle housing includes a first wheel opening comprising a first wheel opening flange and a drive shaft opening comprising a drive shaft opening flange; and. The paint masking system also includes a spring device for paint masking the axle housing. The spring device includes a top plate opposite a bottom plate, wherein the top plate is secured to the bottom plate by a securing rod. The spring device also includes an intermediate plate located between the top plate and the bottom plate and a spring in contact with the intermediate plate and the top plate, wherein the spring is structured and arranged to bias the intermediate plate toward the bottom plate and wherein the intermediate plate is structured and arranged to form a leak tight seal between the intermediate plate and an outer surface of the axle housing when the axle opening flange is clamped between the intermediate plate and the bottom plate.

Further disclosed herein is a spring device for paint masking a component. The spring device includes a top plate opposite a bottom plate, wherein the top plate is secured to the bottom plate by a securing rod. The spring device also includes an intermediate plate located between the top plate and the bottom plate and a spring in contact with the intermediate plate and the top plate, wherein the spring is structured and arranged to bias the intermediate plate toward the bottom plate and wherein the intermediate plate is structured and arranged to form a leak tight seal between the intermediate plate and an outer surface of an opening of the component when the component is clamped between the intermediate plate and the bottom plate.

Further disclosed herein is a method for paint masking an axle housing including installing a spring device onto the axle housing. The installation includes compressing at least one spring of the spring device, wherein the at least one spring secures a top plate to an intermediate plate of the spring device, thus increasing a gap between the intermediate plate and a bottom plate of the spring device, wherein the intermediate plate is located between the top plate and the bottom plate, and wherein the bottom plate is secured to the top plate with at least one securing rod. Installation further includes inserting the bottom plate into an axle opening of the axle housing such that the intermediate plate and the bottom plate are located opposite each other around an axle opening flange extending radially from the axle opening, aligning a plug head of at least one plug of the bottom plate with the axle opening flange, wherein the plug head extends toward the intermediate plate, and decreasing the gap by decompressing the at least one spring until the plug head contacts a bottom surface of the axle opening flange and the intermediate plate forms a leak tight connection with a top surface of the axle opening flange. The method further includes applying a coat of paint to the axle housing and removing the spring device from the axle housing. The removal includes increasing the gap by compressing the at least one spring and removing the bottom plate from the axle opening.

### BRIEF DESCRIPTION OF THE DRAWINGS

FIG. 1 is a side-sectional view of an outer flange paint masking device secured to an axle housing as disclosed herein.

FIG. 2 is a zoomed view of the side-sectional view of the outer flange paint masking device of FIG. 1.

FIG. 3 is side-sectional view of an inner flange paint masking device secured to an axle housing as disclosed herein.

FIG. 4 is an isometric view of an outer flange spring device with compressed springs as disclosed herein.

FIG. 5 is a top view of the outer flange spring device of FIG. 4.

FIG. 6 is a bottom view of the outer flange spring device of FIG. 4.

FIG. 7 is a rear view of the outer flange spring device of FIG. 4.

FIG. 8 is a back view of the outer flange spring device of FIG. 4.

FIG. 9 is a side view of the outer flange spring device of FIG. 4.

FIG. 10 is a side-sectional view of the outer flange spring taken through line 10-10 of FIG. 5.

FIG. 11 is a side view of the outer flange spring device of FIG. 4 with decompressed springs.

FIG. 12 is a top view of an outer gasket of the outer flange spring device of FIG. 4.

FIG. 13 is a bottom view of the outer gasket of FIG. 12.

FIG. 14 is a side view of the outer gasket of FIG. 12.

FIG. 15 is a top isometric view of an inner flange spring device with decompressed springs as disclosed herein.

FIG. 16 is a top view of the inner flange spring device of FIG. 15.

FIG. 17 is a bottom view of the inner flange spring device of FIG. 15.

FIG. 18 is a front view of the inner flange spring device of FIG. 15.

FIG. 19 is a rear view of the inner flange spring device of FIG. 15.

FIG. 20 is a side view of the inner flange spring device of FIG. 15.

FIG. 21 is a front view of the inner flange spring device of FIG. 15 with compressed springs.

FIG. 22 is a side-sectional view of the inner flange spring device taken through line 19-19 of FIG. 16.

FIG. 23 is a side-sectional view of the inner flange spring device taken through line 20-20 of FIG. 16 with bolts as disclosed herein.

FIG. 24 is an isometric view of the inner gasket of FIG. 15.

FIG. 25 is a bottom view of the inner gasket of FIG. 24.

FIG. 26 is a side-sectional view of the gasket taken through line 26-26 of FIG. 25.

FIG. 27 is a schematic flow chart illustrating a method of paint masking a first wheel opening flange of an axle housing with an outer flange spring device as disclosed herein.

FIG. 28 is a schematic flow chart illustrating a method of paint masking a drive shaft flange of an axle housing with an inner flange spring device as disclosed herein.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges, and fractions may be prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When a closed or open-ended numerical range is described herein, all numbers, values, amounts, percentages, subranges, and fractions within or encompassed by the numerical range are to be considered as being specifically included in and belonging to the original disclosure of this application as if these numbers, values, amounts, percentages, subranges, and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” inner plug or “an” inner spring, a combination (i.e., a plurality) of these components can be used.

In addition, in this application, the use of “or” means “and/or” unless specifically stated otherwise, even though “and/or” may be explicitly used in certain instances.

As used herein, “including,” “containing,” and like terms are understood in the context of this application to be synonymous with “comprising” and are therefore open-ended and do not exclude the presence of additional undescribed or unrecited components, elements, materials, ingredients, or method steps. As used herein, “consisting of” is understood in the context of this application to exclude the presence of an unspecified component, element, material, ingredient, or method step. As used herein, “consisting essentially of” is understood in the context of this application to include the specified components, elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “applied onto” an axle housing does not preclude the presence of one or more other intervening coating layers of the same or different composition located between the coating composition and the axle housing.

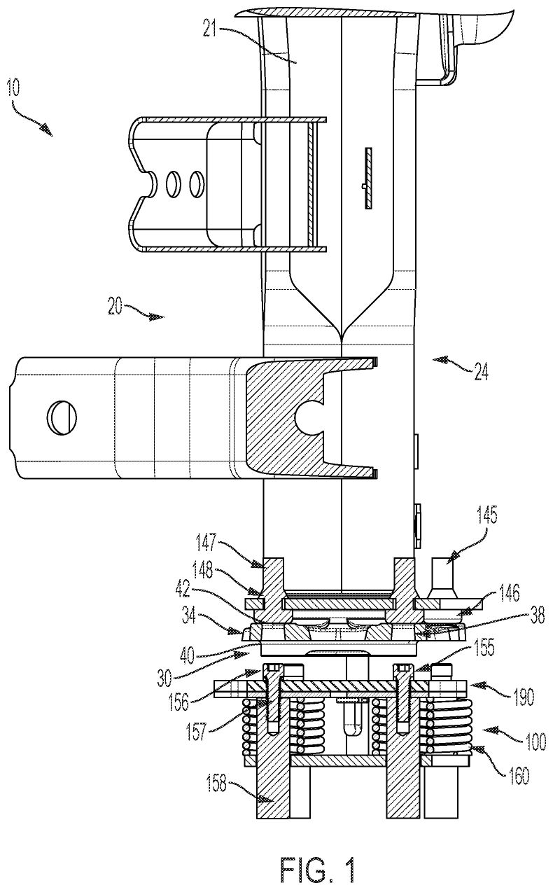

FIGS. 1-3 show a paint masking system 10 comprising a conventional axle housing 20, an outer flange spring device 100 and an inner flange spring device 200. The axle housing 20 may include a first wheel connection 30 and a drive shaft connection 70. The axle housing 20 may be structured and arranged to encompass portions of a conventional axle of a motor vehicle (not shown), such as a car, truck, recreational vehicle, semi-trailer truck and/or the like. The axle housing 20 may be made of a metal, such as steel.

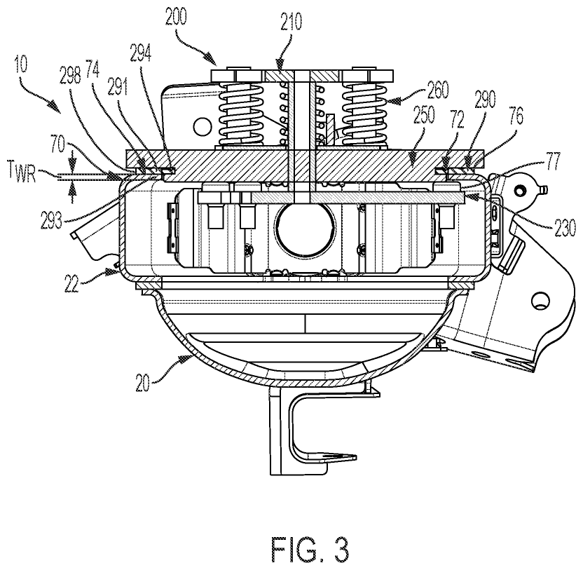

As shown in FIG. 1, the axle housing 20 may include a conventional central shaft 21 which extends to central body 22 shown in FIG. 3. The central body 22 may be hollow and may be structured and arranged to surround a drive shaft of an axle as known to those skilled in the art.

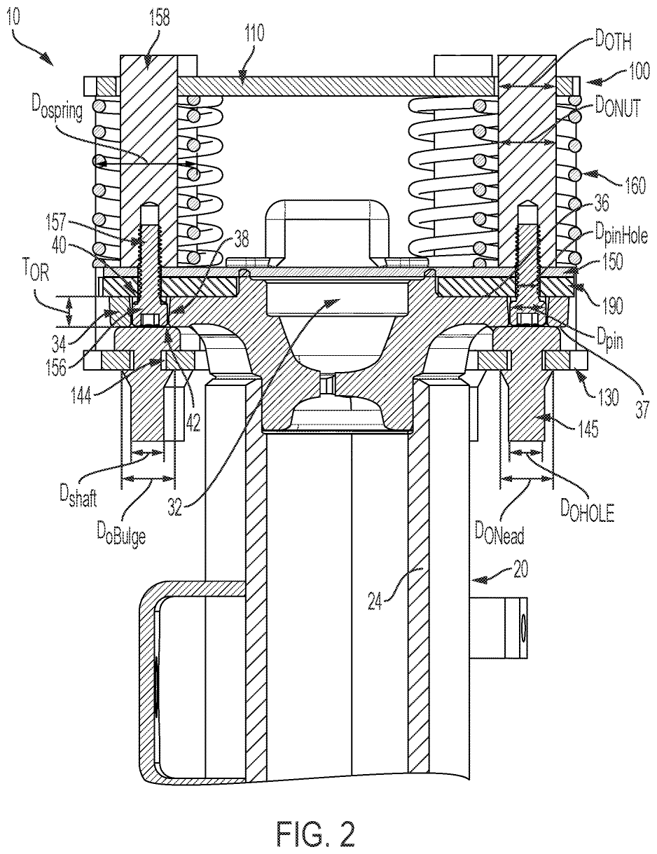

As shown in FIGS. 1-2, the axle housing 20 may comprise a first wheel connection shaft 24 extending radially outward from the central body 22. The first wheel connection shaft 24 may be hollow and may be cylindrical in shape

A second wheel connection shaft (not shown) may extend radially outward from the central body 22. The second wheel connection shaft may be identical to the first wheel connection shaft 24. The second wheel connection shaft may extend in a radial direction opposite of the first wheel connection shaft 24.

The first wheel connection shaft 24 may extend from the central shaft 21 and central body 22 to a first wheel connection 30. The first wheel connection 30 may be structured and arranged to connect to a wheel assembly (not shown), such as connecting to a wheel stud. The first wheel connection 30 may include a first wheel opening 32. The first wheel opening 32 may be aligned with the hollow inside of the first wheel connection shaft 24. The first wheel opening 32 may be located in the center of the first wheel connection 30.

The first wheel connection 30 may include a first wheel opening flange 34 extending radially outward from the first wheel opening 32. The first wheel opening flange 34 may be circular, triangular, square, rectangular, pentagonal or polygonal in shape. The first wheel opening flange 34 may be star shaped with one or more flange arms extending radially outward. The first wheel opening flange 34 may comprise wheel flange thickness T_{WR} measured as the distance between a first wheel outer surface 36 facing away from the central body 22 and a first wheel inner surface 37 facing toward the central body 22. The first wheel outer surface 36 may be parallel to the first wheel inner surface 37. The first wheel outer surface 36 and/or the first wheel inner surface 37 may extend radially outward from the first wheel opening 32.

The first wheel opening flange 34 may include one or more first wheel fastener holes 38 extending from a first wheel fastener hole front end 40 located at the first wheel outer surface 36 to a first wheel fastener hole rear end 42 located at the first wheel inner surface 37. The first wheel fastener hole 38 may be cylindrical in shape. The first wheel fastener hole 38 may be structured and arranged to receive a fastener, such as a bolt, screw, hook and/or the like. The first wheel fastener holes 38 may be arranged equidistant from the center of the first wheel opening 32. The first wheel fastener holes 38 may be arranged to be equidistant from each other along a circumference of a circle.

As shown in FIG. 3, the drive shaft connection 70 may extend radially outward from the central body 22. The drive shaft connection 70 may extend in a direction perpendicular to the radial direction of the first wheel connection shaft 24 and/or the second wheel connection shaft 26.

The drive shaft connection 70 may be structured and arranged to connect to a drive shaft assembly (not shown). The drive shaft connection 70 may include a drive shaft opening 72. The drive shaft opening 72 may extend directly to the hollow inside of the central body 22 or may be aligned with the hollow inside of a connection shaft extending to the central body 22. The drive shaft opening 72 may be located in the center of the drive shaft connection 70.

The drive shaft opening 72 may include a drive shaft opening flange 74 extending radially inward from the drive shaft opening 72. The drive shaft opening flange 74 may be circular, triangular, square, rectangular, pentagonal and/or the like in shape. The drive shaft opening flange 74 may be star shaped with one or more flange arms extending radially inward. The drive shaft opening flange 74 may include a flange notch 75 such that a portion of the drive shaft opening flange 74 does not extend as far radially inward as the remaining portions of the drive shaft opening flange 74.

The drive shaft opening flange 74 may include a drive shaft flange thickness TDR measured as the distance between a drive shaft outer surface 76 facing radially outward from the central body 22 and a drive shaft inner surface 77 facing radially inward to the central body 22. The drive shaft outer surface 76 may be parallel to the drive shaft inner surface 77. The drive shaft outer surface 76 and/or the drive shaft inner surface 77 may extend radially inward from the drive shaft opening 72.

One or more additional connections may extend from central body 22 or may be connected to the central body 22. The additional connections may include an opening with a flange extending radially inward to the opening or radially outward from the opening. The flange may include one or more fastener holes extending from the outer surface of the flange facing away from the central body 22 to the inner surface of the flange facing toward the central body 22.

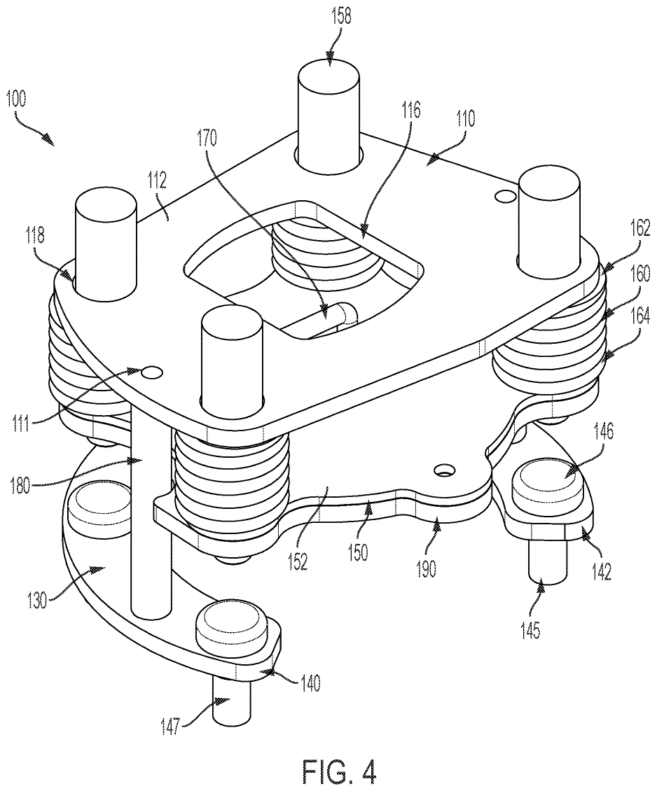

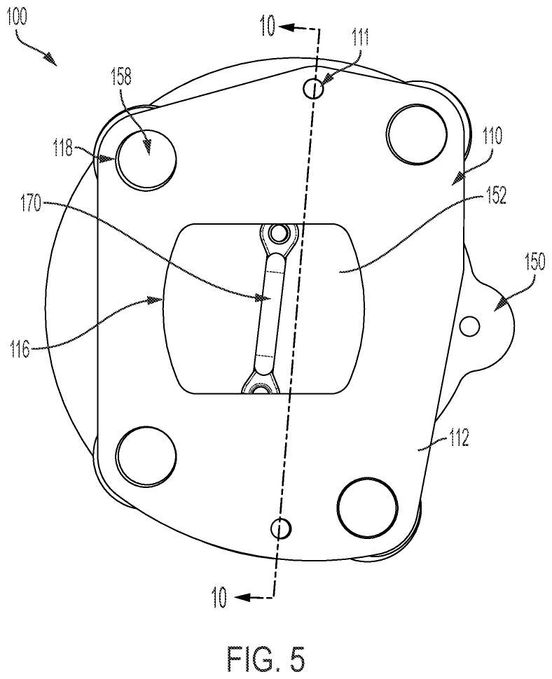

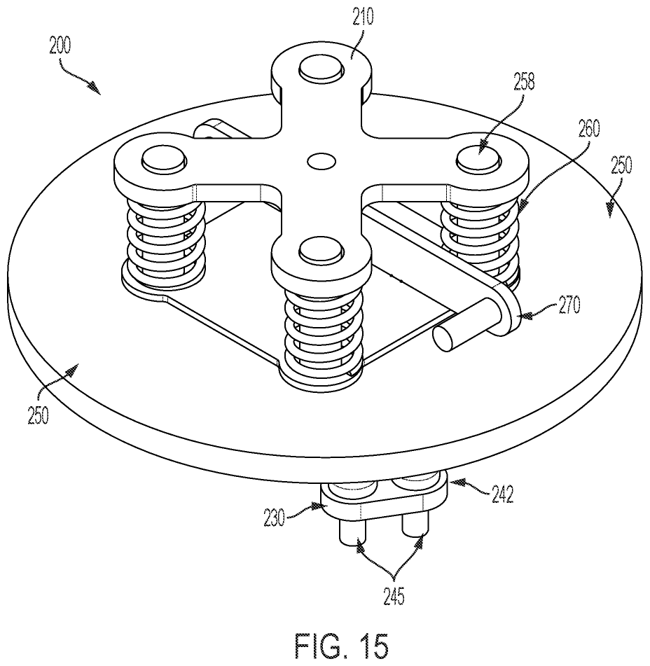

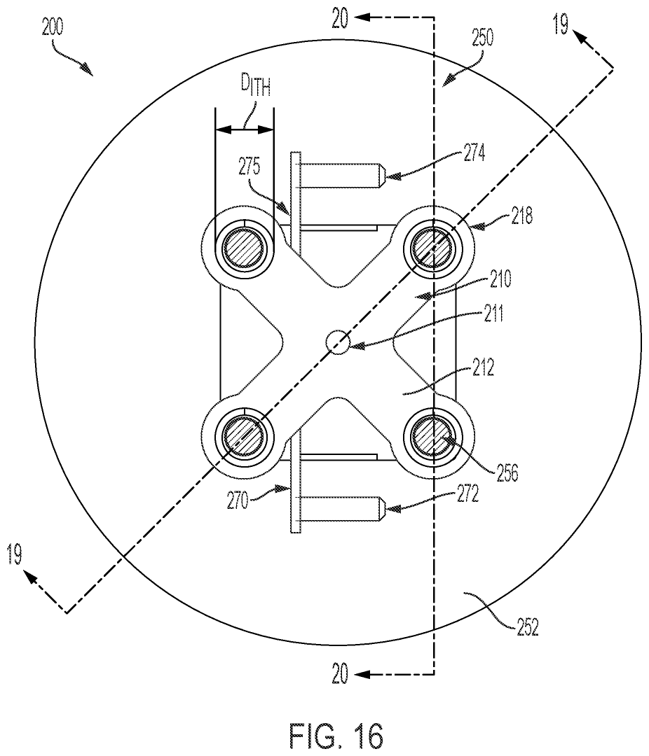

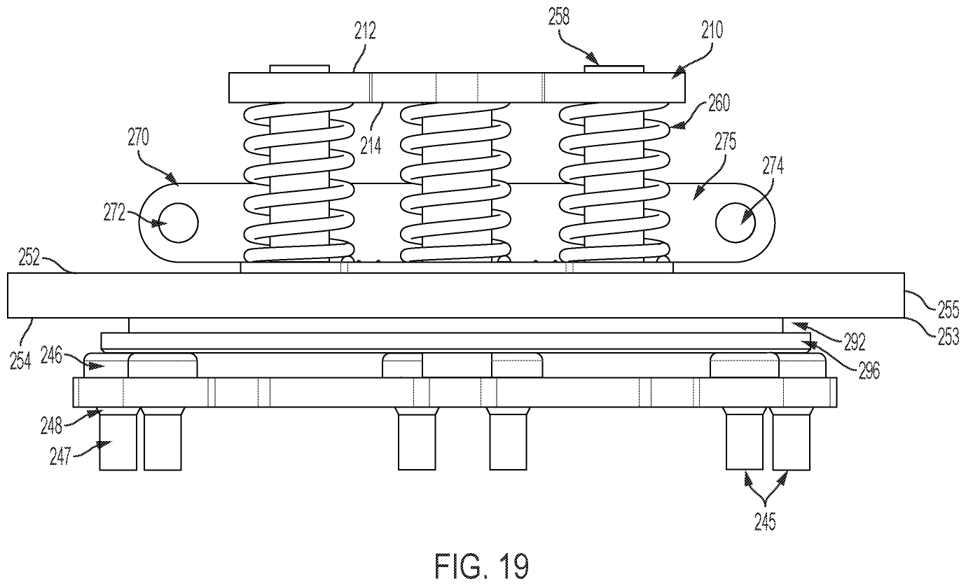

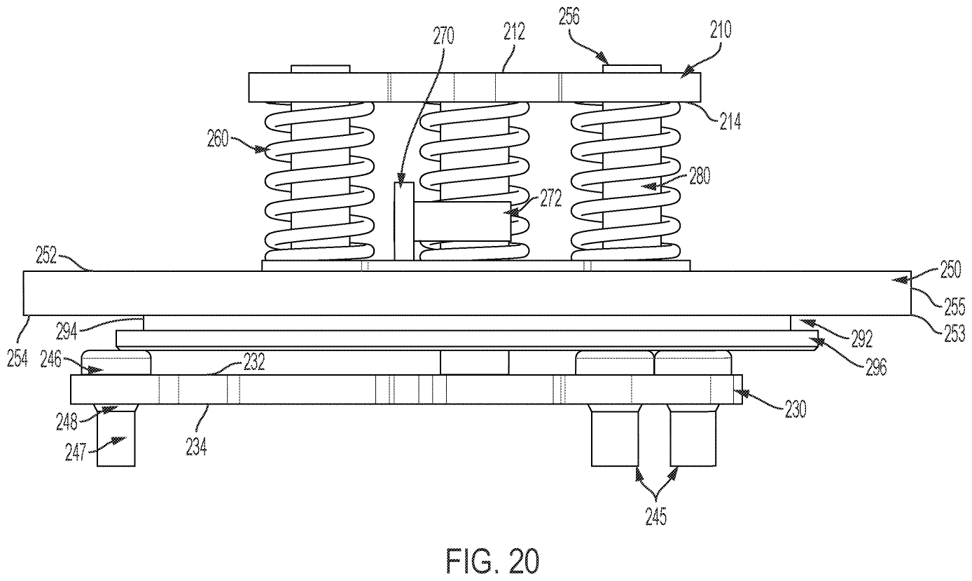

A masking device may be secured to the openings of the axle housing 20. The masking device may prevent paint from entering the interior of the axle housing 20. As used herein, “paint” includes paint and other coatings conventionally applied to axle housings. Paint may be applied to the axle housing 20 through various methods, such as spray painting, immersion, rolling, electrocoating, etc. The masking device may be an outer flange spring device 100, as shown in FIGS. 4-11, structured and arranged to clamp onto an opening flange extending radially outward from the opening, such as the first wheel opening flange 34. The masking device may be an inner flange spring device 200, as shown in FIGS. 15-23, structured and arranged to clamp onto an opening flange extending radially into the opening, such as the drive shaft opening flange 74.

As shown in FIG. 4, the outer flange spring device 100 may include an outer top plate 110 opposite an outer bottom plate 130. The outer top plate 110 may be parallel to the outer bottom plate 130. The outer top plate 110 may be circular, triangular, rectangular, pentagonal, or polygonal in shape. The outer top plate 110 may include an outer top plate opening 116 that extends from an outer top plate top surface 112 to the outer top plate bottom surface 114 opposite the outer top plate top surface 112.

The outer bottom plate 130 may extend from an outer bottom plate top surface 132 to an outer bottom plate bottom surface 134. The outer bottom plate top surface 132 may be oriented to face the outer top plate bottom surface 114.

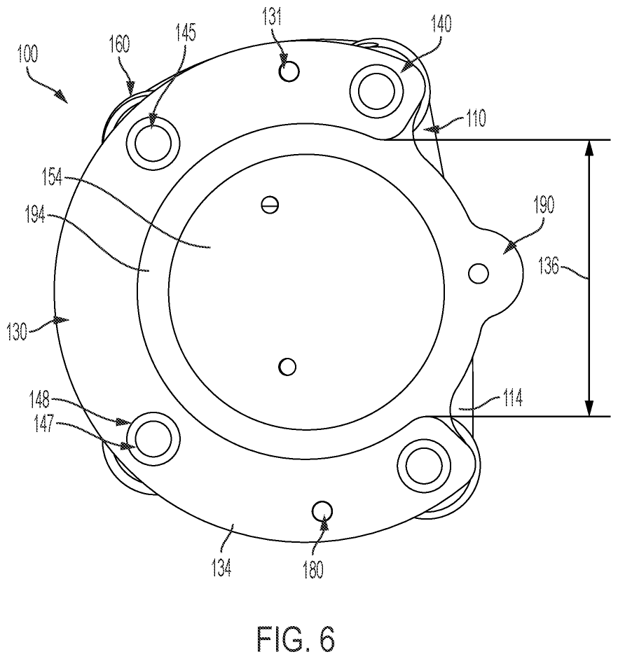

As shown in FIG. 6, the outer bottom plate 130 may form a horseshoe or U-shape such that an outer bottom plate gap 136 is formed between an outer plate first end 140 of the U-shape and an outer plate second end 142 of the U-shape. The outer bottom plate gap 136 may be wider than an outer circumference of a component or pipe, such as the first wheel connection shaft 24 or the second wheel connection shaft 26. The outer bottom plate gap 136 may be structured and arranged to allow the outer bottom plate 130 to be placed around an outer circumference of the component or pipe, or to allow the outer bottom plate 130 to slide radially inward toward the center of the component or pipe, so that the outer bottom plate 130 surrounds at least a portion of the outer circumference of the component or pipe.

The outer bottom plate 130 may include one or more outer plugs 145. The outer plugs 145 may include a flexible material. The outer plugs 145 may include an insulating material, such as rubber. The outer plugs 145 may extend from an outer plug head 146 to an outer plug shaft 147. The outer plug shaft 147 may extend through an outer plug hole 144 extending from the outer bottom plate bottom surface 134 through the outer bottom plate top surface 132.

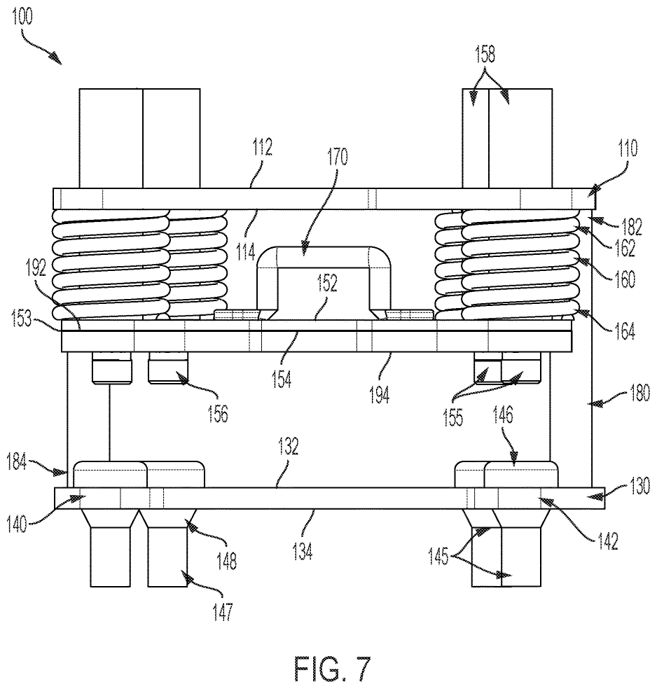

As shown in FIGS. 7-9, the outer plug head 146 may contact the outer bottom plate top surface 132 such that the outer plug head 146 faces the outer top plate 110. The outer plug head diameter D_{OHead} may be larger than the outer plug hole diameter D_{OHole}. The outer plug shaft diameter D_{OShaft} may be smaller than the outer plug hole diameter D_{OHole}. The outer plug shaft 147 may include an outer plug bulge 148 with an outer plug bulge diameter D_{OBulge} that is greater than the outer plug hole diameter D_{OHole}. The outer plug bulge 148 may be structured and arranged to contact the outer bottom plate bottom surface 134 and may secure the outer plug 145 to the outer bottom plate 130.

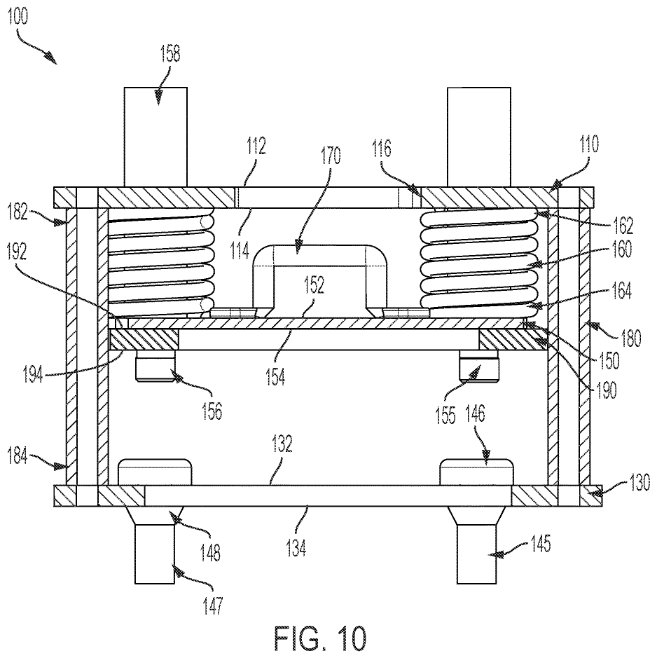

As shown in FIG. 10, the outer top plate 110 may be secured to the outer bottom plate 130 by one or more outer securing rods 180, such as two, three, four, or five outer securing rods 180. The outer securing rod 180 may extend from an outer securing rod top portion 182 to an outer securing rod bottom portion 184. The outer securing rod top portion 182 may be secured to the outer top plate 110. The outer securing rod bottom portion 184 may be secured to the outer bottom plate 130.

The outer securing rod 180 may be a cylinder. The cross section of the outer securing rod 180 may be circular, triangular, rectangular, pentagonal or polygonal in shape. The connection between the outer securing rod 180 and the outer top plate 110 and/or the outer bottom plate 130 may be a threaded connection, a welded connection, a bolted connection, a fastened connection, and/or the like. The outer securing rod top portion 182 may be welded to the outer top plate bottom surface 114. The outer securing rod bottom portion 184 may be welded to the outer bottom plate top surface 132.

The outer securing rod 180 may be hollow. A securing bolt may extend within the hollow interior of the outer securing rod 180. One end of the securing bolt may contact the outer top plate top surface 112 and the opposite end may contact the outer bottom plate bottom surface 134. The bolt may be secured to outer flange spring device 100 with a nut on a threaded connection.

As shown in FIGS. 7-11, an outer intermediate plate 150 may be located between the outer top plate 110 and the outer bottom plate 130. The outer intermediate plate 150 may extend from an outer intermediate plate top surface 152 to an outer intermediate plate bottom surface 154. The outer intermediate plate 150 may be arranged such that the outer intermediate plate top surface 152 faces the outer top plate bottom surface 114 and the outer intermediate plate bottom surface 154 faces the outer bottom plate top surface 132.

The outer intermediate plate 150 may be secured to the outer top plate 110 by one or more outer springs 160, such as two, three, four, five, or six outer springs 160. The outer spring 160 may extend from an outer spring top end 162 secured to the outer top plate bottom surface 112 to an outer spring bottom end 164 secured to the outer intermediate plate top surface 152. The outer spring 160 may be secured through welding, a fastener, and/or the like. The outer spring 160 may comprise a metallic material, such as steel.

The outer spring 160 may be a compression spring. The outer spring 160 may bias the outer intermediate plate 150 away from the outer top plate 110 and may bias the outer intermediate plate 150 toward the outer bottom plate 130. The outer spring 160 may be rated at least 70 pounds per inch compression, for example, at least 75 pounds per inch compression or at least 80 pounds per inch compression. The outer spring 160 may be rated at most 90 pounds per inch compression, for example, at most 85 pounds per inch compression or at most 80 pounds per inch compression. The outer spring 160 may range from 70 pounds per inch compression to 90 pounds per inch compression, for example, from 75 pounds per inch compression to 85 pounds per inch compression.

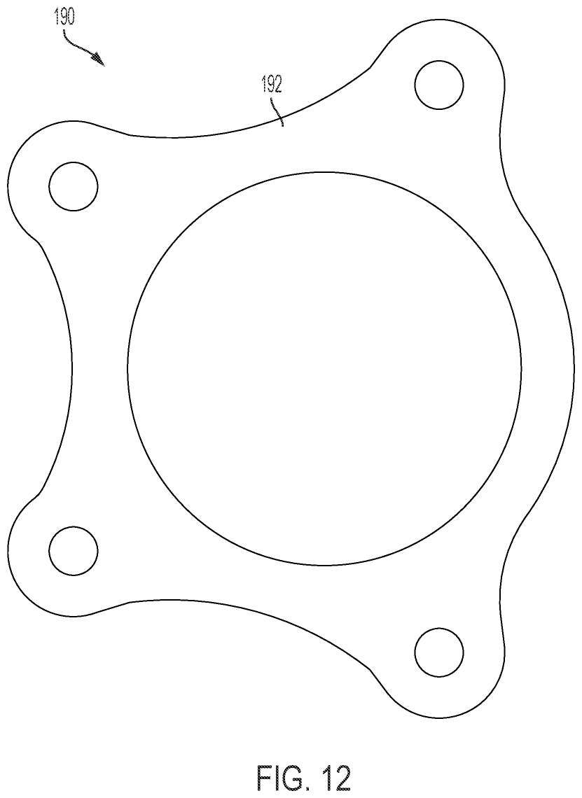

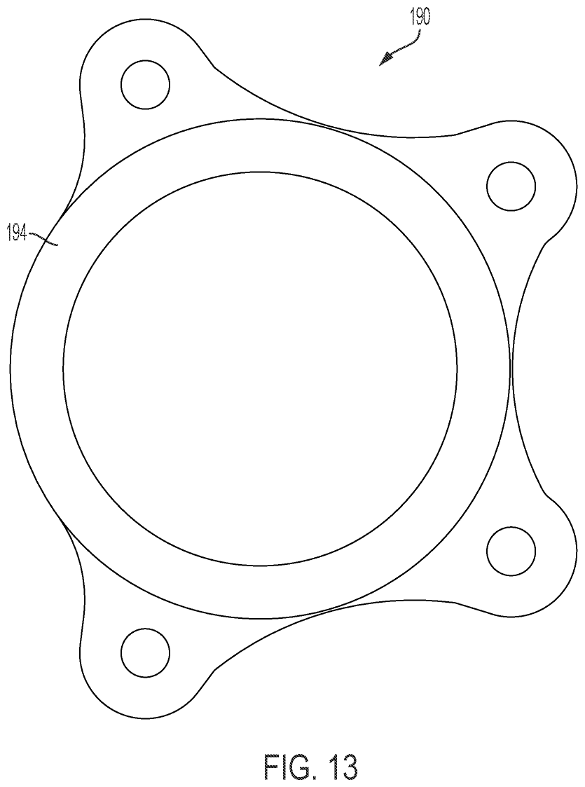

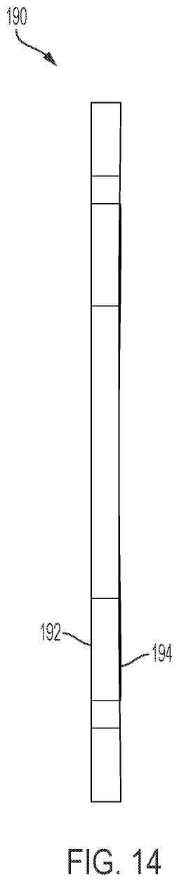

The outer intermediate plate 150 may include an outer gasket 190, as shown in FIGS. 12-14. The outer gasket 190 may be structured and arranged to form a leak tight seal between the outer intermediate plate bottom surface 154 and a surface of a component located between the outer intermediate plate bottom surface 154 and the outer bottom plate top surface 132. As used herein, a “leak tight seal” means sufficient contact or engagement between an intermediate plate 150 and an outer surface of the axle housing 20 to is provided such that the flow of paint in the engagement region is substantially reduced or eliminated. The outer gasket top surface 192 may come in contact with the intermediate plate bottom surface 154. The outer gasket bottom surface 194 may come in contact with the surface of the component, such as the first wheel outer surface 36. The outer gasket 190 may include an elastomeric material such as natural or synthetic rubber or the like. The outer gasket 190 may be secured to the outer intermediate plate bottom surface 154. The outer gasket 190 may be shaped to follow the shape of the outer intermediate plate 150. The outer gasket outer surface 196 may follow the outer intermediate plate outer edge 153.

As shown in FIGS. 1-2 and 7-11, the outer intermediate plate 150 may include one or more outer alignment pins 155, such as two, three, four, five, or six alignment pins 155. The number of alignment pins 155 may equal the number of outer springs 160. The number of alignment pins 155 may equal the number of first wheel fastener holes 38 of the first wheel connection 30 of the axle housing 20. The alignment pins 155 may be structured and arranged to align with the first wheel fastener holes 38.

The outer alignment pin 155 may include an outer alignment pin head 156 in contact with the outer intermediate plate bottom surface 154 and facing the outer bottom plate top surface 132. The outer alignment pin head 156 may include an electrically insulating material. The outer alignment pin head 156 may be structured and arranged to be inserted inside of the first wheel fastener holes 38 and may form a leak tight seal between the outer alignment pin 155 and the first wheel fastener hole 38. The outer alignment pin head 156 may be structured and arranged to secure the outer gasket 190 to the intermediate plate 150 and may contact the outer gasket bottom surface 194.

An outer alignment pin shaft 157 may extend from the outer alignment pin head 156 toward the outer top plate 110. The outer alignment pin shaft 157 may extend through an outer intermediate plate alignment hole 151 that extends from the outer intermediate plate bottom surface 154 to the outer intermediate plate top surface 152. The outer alignment pin head diameter D_{Pin} may be larger than the outer intermediate plate alignment hole diameter D_{PinHole}.

An outer alignment pin nut 158 may attach to the outer alignment pin shaft 157, securing the outer alignment pin 155 to the outer intermediate plate 150. The outer alignment pin nut 158 may engage at least a portion or the entire portion of the outer alignment pin shaft 157 extending beyond the outer intermediate plate top surface 152. The outer alignment pin nut 158 may include an electrically insulating material. The outer alignment pin nut 158 may be cylindrical. The outer alignment pin nut 158 may extend from the outer intermediate plate top surface 152 toward the outer top plate 110.

The outer alignment pin nut 158 may extend through an outer top plate alignment hole 118 of the outer top plate 110. The outer top plate alignment hole 118 may extend from the outer top plate bottom surface 114 through the outer top plate top surface 112. The outer top plate alignment hole 118 may align in the longitudinal direction with the outer intermediate plate alignment hole 151. The outer top plate alignment hole diameter D_{OTH} may be larger than the outer alignment pin nut diameter D_{ONut}.

The outer spring 160 may be aligned in the longitudinal direction with the outer intermediate plate alignment hole 151 and the outer top plate alignment hole 118. The outer spring inner diameter D_{Ospring} may be larger than the outer intermediate plate alignment hole diameter D_{PinHole}, the outer top plate alignment hole diameter D_{OTH} and the outer alignment pin nut diameter D_{ONut}. The outer spring 160 may be structured and arranged such that the outer alignment pin nut 158 extends through the center of the outer spring 160. The outer spring top end 162 may surround the outer top plate alignment hole 118 and the outer spring bottom end 164 may surround the outer intermediate plate alignment hole 151.

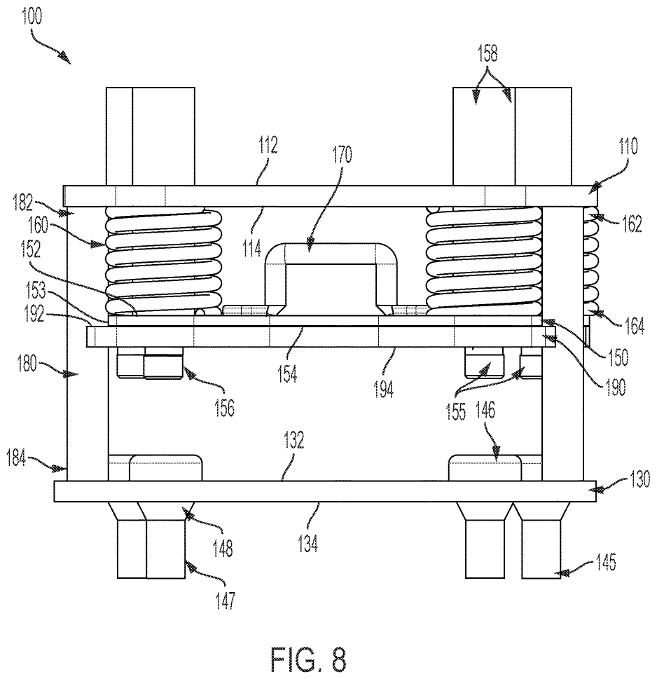

As shown in FIG. 8, the outer intermediate plate 150 may include an outer handle 170 secured to the outer intermediate plate top surface 152. The outer handle 170 may align in the longitudinal direction with the outer top plate opening 116. The outer handle 170 may be structured and arranged to be gripped by the hand of a user or by a machine. A machine may apply a predetermined pulling force to the outer handle 170 and may move the outer handle 170 to a predetermined distance.

The outer handle 170 may be structured and arranged such that a pulling force can be applied to the outer handle 170, pulling the outer handle 170 toward the outer top plate 110. As the outer handle 170 is pulled toward the outer top plate 110, the outer spring 160 is compressed. As the outer spring 160 is compressed, the outer intermediate plate 150 is moved away from the outer bottom plate 130 and toward the outer top plate 110, increasing a length of an outer plate gap distance L_{OPG}.

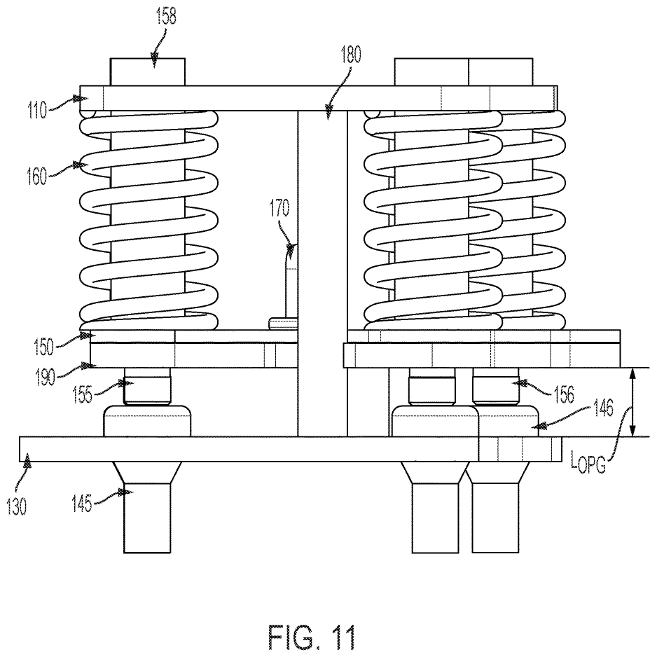

As shown in FIG. 11, the outer plate gap distance L_{OPG} may be measured as the distance between the outer bottom plate top surface 132 and the outer intermediate plate bottom surface 154. When the outer spring 160 is fully compressed, the outer plate gap distance L_{OPG} may be greater than a flange thickness of a component, such as the wheel flange thickness T_{WR}. When the outer spring 160 is fully compressed, the outer plate gap distance L_{OPG} may be at least 0.25 inches, for example, at least 0.5 inches or at least 1 inch. When the outer spring 160 is fully compressed, the outer plate gap distance L_{OPG} may be at most 2 inches, for example, at most 1.5 inches or at most 1 inch. When the outer spring 160 is fully compressed, the outer plate gap distance L_{OPG} may range from 0.25 inches to 2 inches, for example, from 0.5 inches to 1.5 inches.

As shown in FIG. 15, the inner flange spring device 200 may include an inner top plate 210 opposite an inner bottom plate 230. The inner top plate 210 may be parallel to the inner bottom plate 230. The inner top plate 210 may be circular, triangular, rectangular, pentagonal, or polygonal in shape. The inner top plate 210 may be X-shaped.

The inner bottom plate 230 may extend from an inner bottom plate top surface 232 to an inner bottom plate bottom surface 234. The inner bottom plate top surface 232 may be oriented to face the inner top plate bottom surface 214.

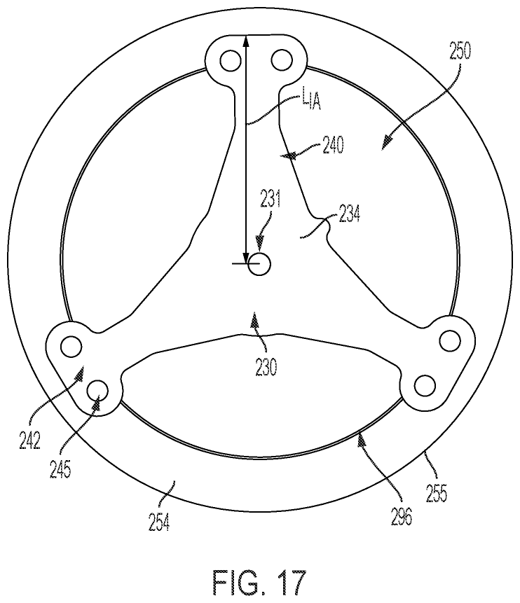

As shown in FIG. 17, the inner bottom plate 230 may form a star shape with one or more inner arms 240, such as one, two, three, four, five, or six inner arms 240, extending radially outward from the center of the inner bottom plate 230 to an inner arm end 242. The inner arm length L_{IA}, measured as the distance between the center of the inner bottom plate 230 and the edge of the inner arm end 242, may be longer than the inner radius of flange extending radially inward from an opening, but shorter than the outer radius of the opening. For example, the inner arm length L_{IA} may be longer than the inner radius of the draft shaft opening flange 70, but shorter than the radius of the drive shaft opening 72.

The inner arm 240 may be widest near the center of the inner bottom plate 230 and thin as it extends radially outward. The inner arm 240 may then widen as it reaches the inner arm end 242. The inner arm end 242 may be structured and arranged to fit within a flange notch 75.

The inner bottom plate 230 may include one or more inner plugs 245 located in each inner arm end 242. The inner plugs 245 may be the same or similar to the outer plugs 145. The inner plugs 245 may include a flexible material. The inner plugs 245 may include an insulating material, such as rubber. The inner plugs 245 may extend from an inner plug head 246 to an inner plug shaft 247. The inner plug shaft 247 may extend through an inner plug hole 244 extending from the inner bottom plate bottom surface 234 through the inner bottom plate top surface 232.

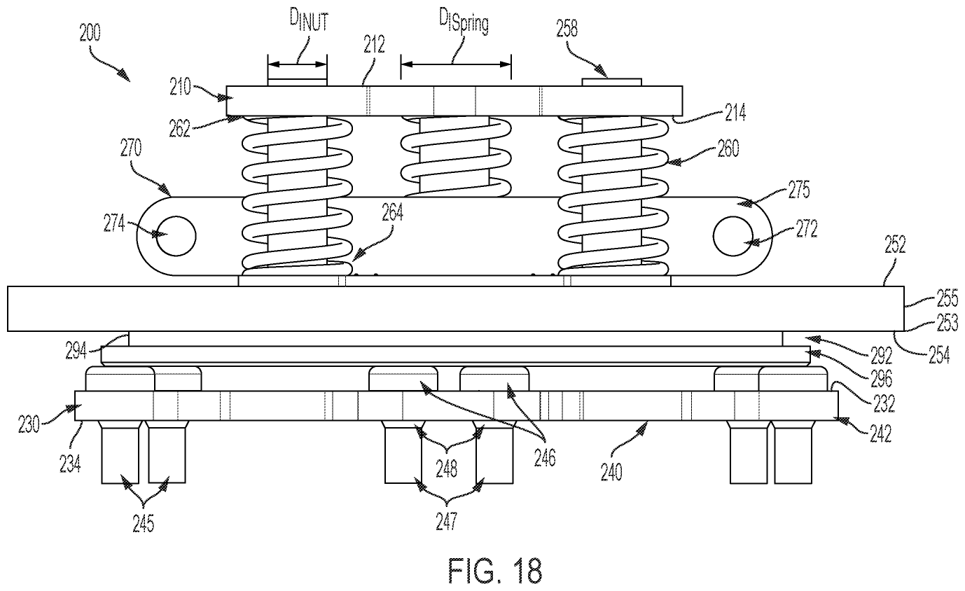

As shown in FIGS. 18-21, the inner plug head 246 may contact the inner bottom plate top surface 232 such that the inner plug head 246 faces the inner top plate 210. The inner plug head diameter D_{IHead} may be larger than the inner plug hole diameter D_{IHole}. The inner plug shaft diameter D_{IShaft} may be smaller than the inner plug hole diameter D_{IHole}. The inner plug shaft 247 may include an inner plug bulge 248 with an inner plug bulge diameter D_{IBulge} that is greater than the outer inner hole diameter D_{IHole}. The inner plug bulge 248 may be structured and arranged to contact the inner bottom plate bottom surface 234 and may secure the inner plug 245 to the inner bottom plate 230.

The inner top plate 210 may be secured to the inner bottom plate 230 by one or more inner securing rods 280, such as two, three, four, or five inner securing rods 280. The inner securing rod 280 may extend from an inner securing rod top portion 282 to an inner securing rod bottom portion 284. The inner securing rod 280 may extend from the center of the inner top plate 210 to the center of the inner bottom plate 230. The inner securing rod top portion 282 may be secured to the inner top plate 210. The inner securing rod bottom portion 284 may be secured to the inner bottom plate 230.

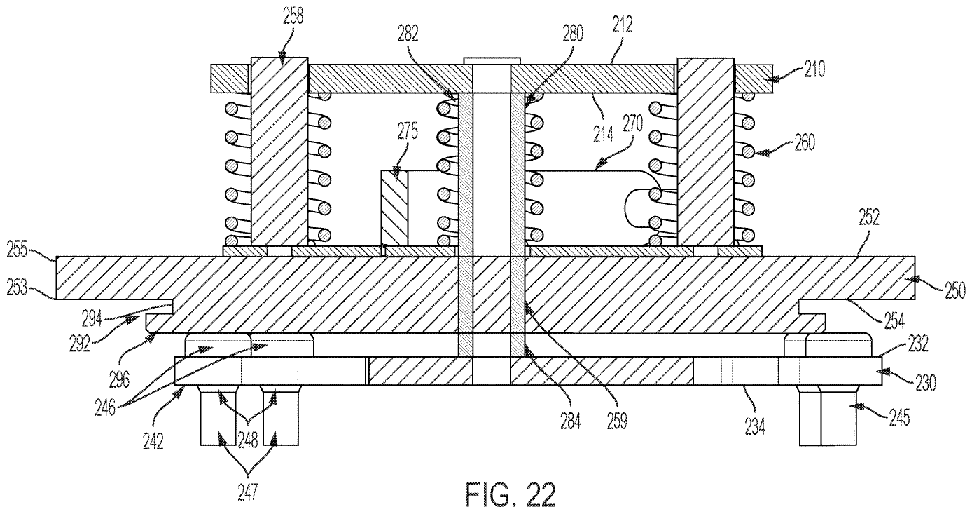

As shown in FIG. 22, the inner securing rod 280 may be a cylinder. The cross section of the inner securing rod 280 may be circular, triangular, rectangular, pentagonal or polygonal in shape. The connection between the inner securing rod 280 and the inner top plate 210 and/or the inner bottom plate 230 may be a threaded connection, a welded connection, a bolted connection, a fastened connection, and/or the like. The inner securing rod top portion 282 may be welded to the inner top plate bottom surface 214. The inner securing rod bottom portion 284 may be welded to the inner bottom plate top surface 232.

The inner securing rod 280 may be hollow. A securing bolt (not shown) may extend within the hollow interior of the inner securing rod 280. One end of the securing bolt may contact the inner top plate top surface 212 and the opposite end may contact the inner bottom plate bottom surface 234. The securing bolt may be secured to inner flange spring device 200 with a nut on a threaded connection.

An inner intermediate plate 250 may be located between the inner top plate 210 and the inner bottom plate 230. The inner intermediate plate 250 may extend from an inner intermediate plate top surface 252 to an inner intermediate plate bottom surface 254. The inner intermediate plate 250 may be arranged such that the inner intermediate plate top surface 252 faces the inner top plate bottom surface 214 and the inner intermediate plate bottom surface 254 faces the inner bottom plate top surface 232.

The inner intermediate plate 250 may be secured to the inner top plate 210 by one or more inner springs 260, such as two, three, four, five, or six inner springs 260. The inner spring 260 may be the same as or similar to the outer spring 260. The inner spring 260 may extend from an inner spring top end 262 secured to the inner top plate bottom surface 212 to an inner spring bottom end 264 secured to the inner intermediate plate top surface 252. The inner spring 260 may be secured through welding, a fastener, and/or the like. The inner spring 260 may comprise a metallic material, such as steel.

The inner spring 260 may be a compression spring. The inner spring 260 may bias the inner intermediate plate 250 away from the inner top plate 210 and may bias the inner intermediate plate 250 toward the inner bottom plate 230. The inner spring 260 may be rated at least 90 pounds per inch compression, for example, at least 95 pounds per inch compression or at least 100 pounds per inch compression. The inner spring 260 may be rated at most 110 pounds per inch compression, for example, at most 115 pounds per inch compression or at most 100 pounds per inch compression. The inner spring 260 may range from 90 pounds per inch compression to 110 pounds per inch compression, for example, from 95 pounds per inch compression to 115 pounds per inch compression.

The inner intermediate plate bottom surface 254 may include an inner gasket slot 292 structured and arranged to receive an inner gasket 290. For illustrative purposes, the inner gasket 290 is not shown in FIGS. 15-20. The inner gasket slot 292 may extend from the inner intermediate plate outer surface 255 radially inward to an inner gasket slot inner surface 294. The inner gasket slot 292 may include an inner gasket slot lip 296 that extends radially outward from the inner gasket slot inner surface 294 and overhangs at least a portion of the inner gasket slot 292.

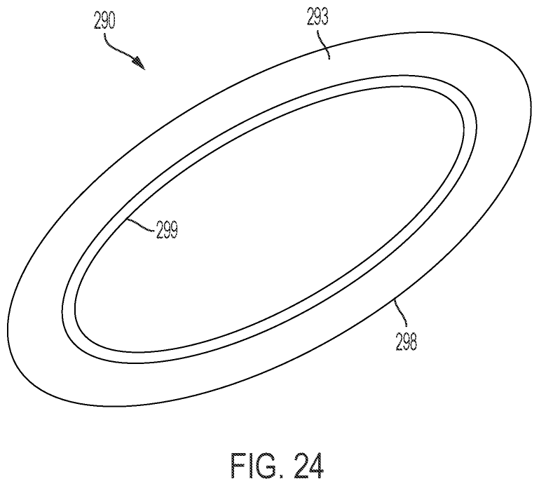

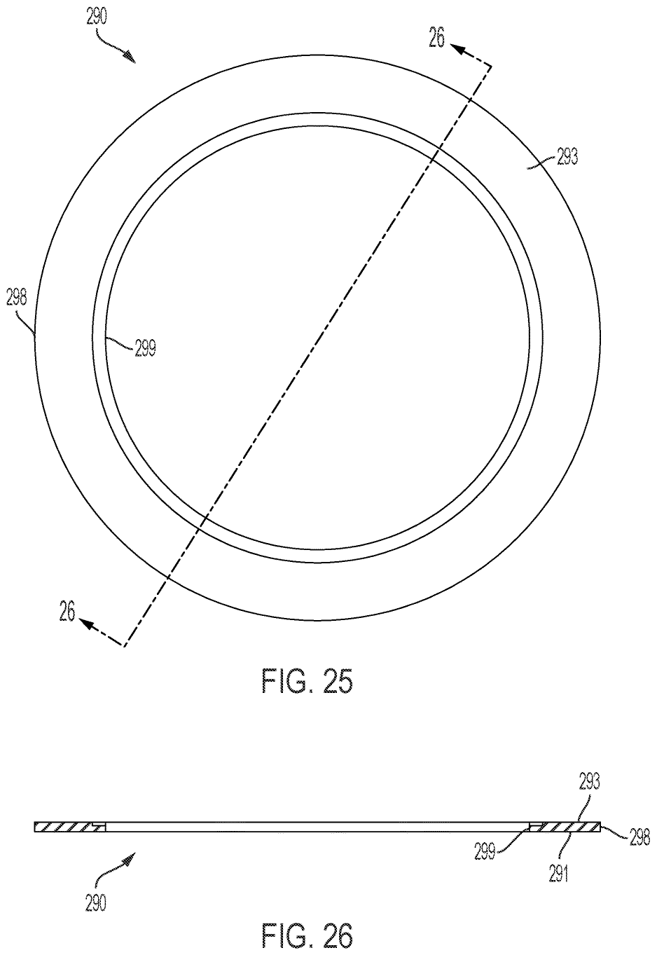

As shown in FIG. 3, the inner intermediate plate 250 may also include an inner gasket 290 is schematically shown. The inner gasket 290, as shown in detail in FIGS. 24-26, may include an electrical insulating material and may include an elastomeric material such as natural or synthetic rubber or the like. The inner gasket 290 may be an O-ring. The inner gasket top surface 291 may come in contact with the inner intermediate plate bottom surface 254. The inner gasket 290 may be structured and arranged to form a leak tight seal between the inner intermediate plate bottom surface 254 and a surface of a component located between the inner intermediate plate bottom surface 254 and the inner bottom plate top surface 232. The inner gasket 290 may be secured to the inner intermediate plate bottom surface 254. The inner gasket 290 may be shaped to follow the shape of the inner intermediate plate 250. The inner gasket outer surface 298 may follow the inner intermediate plate outer edge 253 and may stay within the inner intermediate plate outer edge 253. The inner gasket inner surface 299 may be secured in the inner gasket slot 292 by the inner gasket slot lip 296.

The inner intermediate plate 250 may include one or more inner intermediate plate securing holes 259, such as two, three, four, five, or six inner intermediate plate securing holes 259. The number of inner intermediate plate securing holes 259 may equal the number of inner securing rods 280. An inner intermediate plate securing hole 259 may be located at the center of the inner intermediate plate 250.

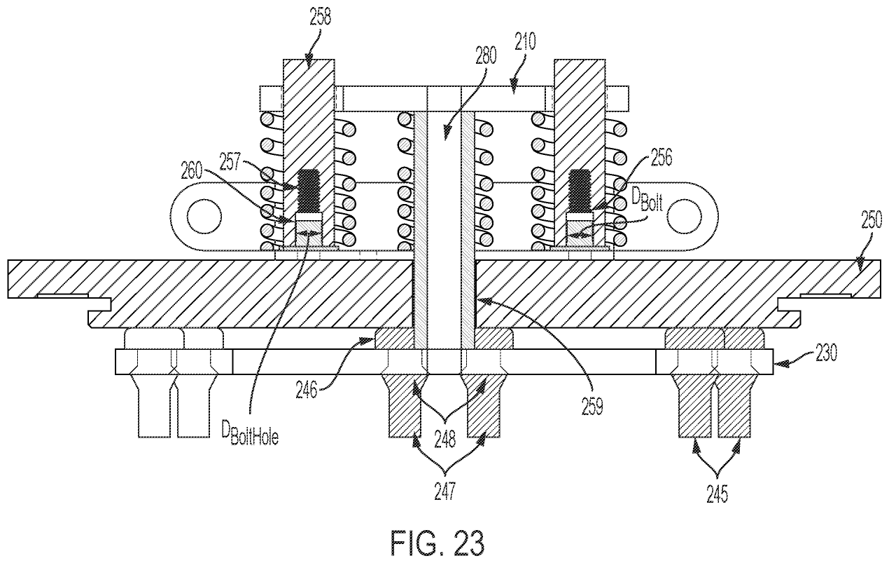

As shown in FIG. 23, the inner intermediate plate 250 may include one or more inner bolts 256. The number of inner bolts 256 may equal the number of inner springs 260. The inner bolt head 261 of the inner bolt 256 may be embedded within the inner intermediate plate 250 or may come in contact with the inner intermediate plate bottom surface 254.

An inner bolt shaft 257 may extend from the inner bolt head 256 toward the inner top plate 210. The inner bolt shaft 257 may extend through an inner intermediate plate bolt hole 251 that extends from the inner intermediate plate bottom surface 254 to the inner intermediate plate top surface 252. The inner bolt head 256 may be secured to the inner intermediate plate top surface 252.

An inner bolt nut 258 may attach to the inner bolt shaft 257, securing the inner bolt 256 to the inner intermediate plate 250. The inner bolt nut 258 may engage at least a portion or the entire portion of the inner bolt shaft 257 extending beyond the inner intermediate plate top surface 252. The inner bolt nut 258 may include an electrically insulating material. The inner bolt nut 258 may be cylindrical. The inner bolt nut 258 may extend from the inner intermediate plate top surface 252 toward the inner top plate 210.

The inner bolt nut 258 may extend through an inner top plate bolt hole 218 of the inner top plate 210. The inner top plate bolt hole 218 may extend from the inner top plate bottom surface 214 through the inner top plate top surface 212. The inner top plate bolt hole 218 may align in the longitudinal direction with the inner intermediate plate bolt hole 251. The inner top plate alignment hole diameter D_{ITH} may be larger than the inner bolt nut diameter D_{INut}.

The inner spring 260 may be aligned in the longitudinal direction with the inner intermediate plate bolt hole 251 and the inner top plate bolt hole 218. The inner spring inner diameter D_{ISpring} may be larger than the inner intermediate plate bolt hole diameter D_{BoltHole}, the inner top plate bolt hole diameter D_{ITH} and the inner bolt nut diameter D_{INut}. The inner spring 260 may be structured and arranged such that the inner bolt nut 258 extends through the center of the inner spring 260. The inner spring top end 262 may surround the inner top plate bolt hole 218 and the inner spring bottom end 264 may surround the inner intermediate plate alignment bolt hole 251.

As shown in FIGS. 18-20, the inner intermediate plate 250 may include an inner handle 270 secured to the inner intermediate plate top surface 252. The inner handle 270 may include a first gripping portion 272 connected to a second gripping portion 274 by a gripping portion connection 275. The first gripping portion 272 and second gripping portion 274 may be structured and arranged such that a direction normal to the inner intermediate top surface through the first gripping portion 272 and second gripping portion 274 may not intersect with the inner top plate 210. The first gripping portion 272 and second gripping portion 274 may extend from the gripping portion connection 275 in a direction parallel to the inner intermediate top surface 252. The gripping portion connection 275 may be a flat plate in shape.

The inner handle 270 may be structured and arranged such that a pulling force can be applied to the inner handle 270, pulling the inner handle 270 toward the inner top plate 210. As the inner handle 270 is pulled toward the inner top plate 210, the inner spring 170 is compressed. As the inner spring 260 is compressed, the inner intermediate plate 250 is moved away from the inner bottom plate 230 and toward the inner top plate 210, increasing a length of an inner plate gap distance L_{IPG}. The inner handle 270 may be structured and arranged to be gripped by the hand of a user or by a machine. A machine may apply a predetermined force to the inner handle 270 and may move the inner handle 270 to a predetermined distance.

The inner plate gap distance L_{IPG} may be measured as the distance between the inner bottom plate top surface 232 and the inner intermediate plate bottom surface 254. When the inner spring 250 is fully compressed, the inner plate gap distance L_{IPG} may be greater than a flange thickness of a component, such as the drive shaft flange thickness T_{DR}. When the inner spring 350 is fully compressed, the inner plate gap distance L_{IPG} may be at least 0.25 inches, for example, at least 0.5 inches or at least 1 inch. When the inner spring 250 is fully compressed, the inner plate gap distance L_{IPG} may be at most 2 inches, for example, at most 1.5 inches or at most 1 inch. When the inner spring 250 is fully compressed, the inner plate gap distance L_{IPG} may range from 0.25 inches to 2 inches, for example, from 0.5 inches to 1.5 inches.

When installed on a component, the outer flange spring device 100 may cause a clamping force onto the first wheel inner surface 37 and the first wheel outer surface 36. The clamping force may cause leak tight seals between the fastener hole rear end 42 and the outer plug head 146, between the fastener hole front end 40 and the outer alignment pin head 156, and between the first wheel opening 32 and the outer gasket 190.

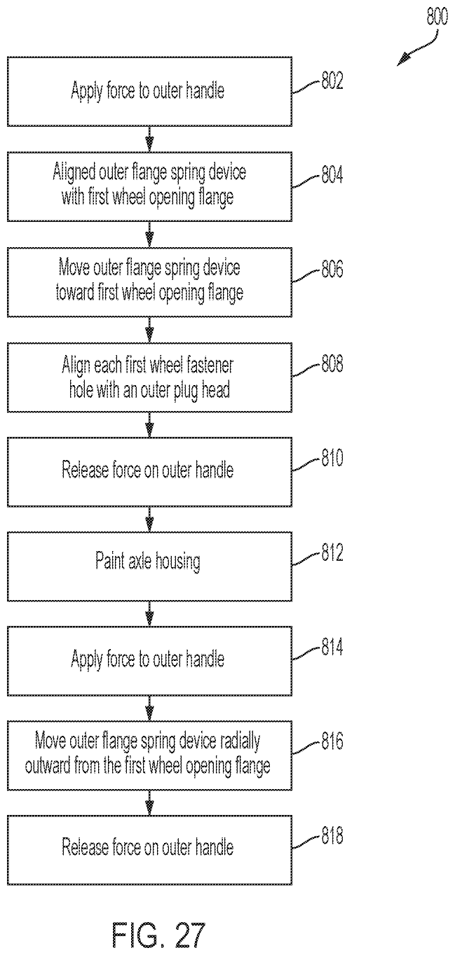

Shown in FIG. 27 is a method 800 of paint masking a first wheel opening flange 34 of an axle housing 20 with an outer flange spring device 100. The steps of this method may be used for other flanges that extend radially outward from their openings.

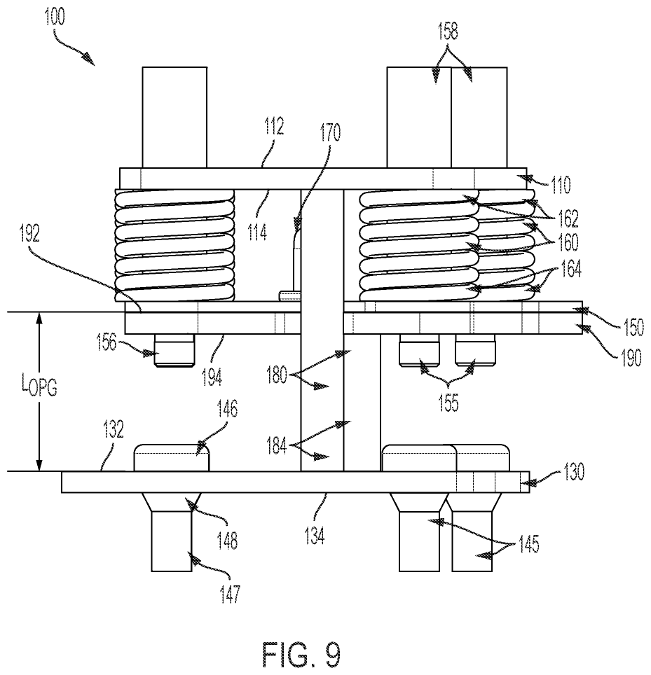

In step 802, a force may be applied to the outer handle 170, causing the outer intermediate plate 150 to move toward the outer top plate 110, thus compressing the outer spring 160 and increasing the gap between the outer intermediate plate 150 and the outer bottom plate 130. The outer flange spring device 100 with the compressed springs 160 is shown in FIG. 9. The force may be applied until after the gap between the intermediate plate 150 and the outer bottom plate 130 exceeds the thickness of the flange of the component to which the outer flange spring device 100 may be intended to mask.

In step 804, the outer flange spring device 100 may be aligned with the first wheel opening flange 34. The first wheel outer surface 36 and first wheel inner surface 37 may be radially between the outer intermediate plate 150 and the outer bottom plate 130. The first wheel outer surface 36 may be oriented to face toward the outer intermediate plate 150 and the first wheel inner surface 37 may be oriented to face toward the outer bottom plate 130. The outer bottom plate gap 136 may be aligned to face the first wheel connection shaft 24.

In step 806, the outer flange spring device 100 may move toward the first wheel opening flange 34. The outer flange spring device 100 may be moved until the center of the first wheel opening 32 aligns with the center of the outer top plate 110.

In step 808, each first wheel fastener hole 38 may be aligned with an outer plug head 145. The outer flange spring device 100 may be rotated in a clockwise or counterclockwise direction around an axis connecting the center of the outer top plate 110 and the center of the first wheel opening 32 until each first wheel fastener hole 38 is aligned with an outer plug head 145. The number of outer plug heads 145 may be equal to or exceed the number of first wheel fastener holes 38.

In step 810, the force on the outer handle 170 may be released. As the force is released, the outer spring 170 may begin to decompress, forcing the outer intermediate plate 150 to move toward the outer bottom plate 130. The outer spring 170 may decompress until the outer flange spring device 100 clamps onto the first wheel opening flange 34. Once the outer spring 170 is decompressed, the outer plug head 145 may contact each of the first wheel fastener hole rear end 42 and the outer alignment pin head 156 may contact each of the first wheel fastener hole front end 40. The clamping force may cause a leak tight seal between the outer alignment pin head 156 and the first wheel fastener hole front end 40 and may cause a leak tight seal between the outer plug head 145 and the first wheel fastener hole rear end. The leak tight seal may prevent particles outside of the axle housing 20 from entering the inside of the axle housing 20 through the first wheel opening 32. The leak tight seal may also prevent particles from outside the first wheel fastener hole 38 from entering the first wheel fastener hole 38 through the first wheel fastener hole front end 40 or the first wheel fastener hole rear end 42.

In step 812, the axle housing 20 is painted. The axle housing 20 may be painted by spray painting, liquid painting, electrocoating, etc. During electrocoating, an electric current may be applied to the axle housing 20 to attract paint particles. However, each outer alignment pin head 156 and outer plug head 146 may decrease the electric current transferring to the outer flange spring device 100 itself due to the electrical insulation of the alignment pin head 156 and outer plug head 146, thus minimizing coatings of paint being applied to the surfaces of the outer flange spring device 100. Decreased coatings may result in a longer life of the outer flange spring device 100.

In step 814, a force may be applied to the outer handle 170, causing the outer intermediate plate 150 to move toward the outer top plate 110, thus decompressing the outer spring 160 and increasing the gap between the outer intermediate plate 150 and the outer bottom plate 130. The force may be applied until after the gap between the outer intermediate plate 150 and the outer bottom plate 130 exceeds the thickness of the first wheel opening flange 34.

In step 816, the outer flange spring device 100 may be moved radially outward from the first wheel opening flange 34 such that the first wheel opening flange 34 may no longer be located between the outer intermediate plate 150 and the outer bottom plate 130.

In step 818, the force on the outer handle 170 may be released. As the force is released, the outer spring 170 may begin to decompress, forcing the outer intermediate plate 150 to move toward the outer bottom plate 130. The outer spring 170 may decompress until the outer plug head 146 comes in contact with the outer alignment pin head 156, as shown in FIG. 11.

When installed on a component, the outer flange spring device 100 may cause a clamping force onto the component, such as on the first wheel inner surface 37 and the first wheel outer surface 36, as shown in FIGS. 1-2. The clamping force may cause leak tight seals between the first wheel fastener hole rear end 42 and the outer plug head 146, between the first wheel fastener hole front end 40 and the outer alignment pin head 156, and between the first wheel opening 32 and the outer gasket 190.

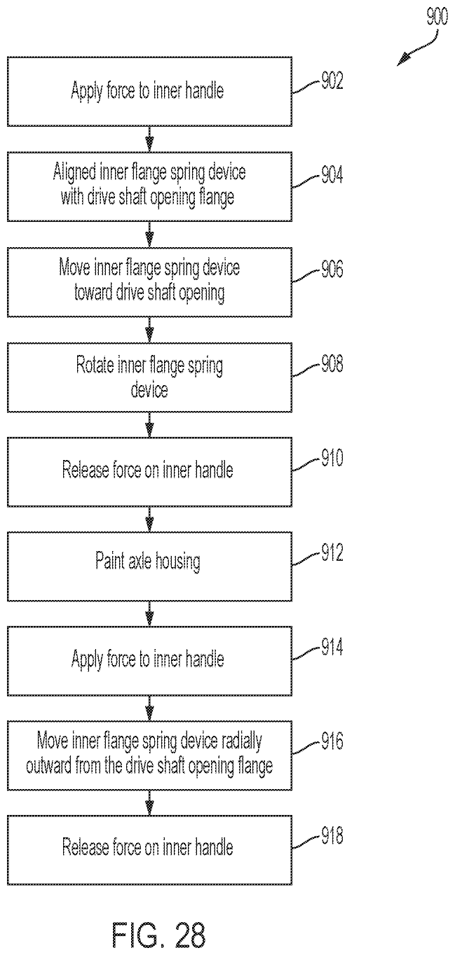

Shown in FIG. 28 is a method 900 of paint masking a drive shaft flange 74 of an axle housing 20 with an inner flange spring device 200. The steps of this method may be used for other flanges that extend radially inward from their openings.

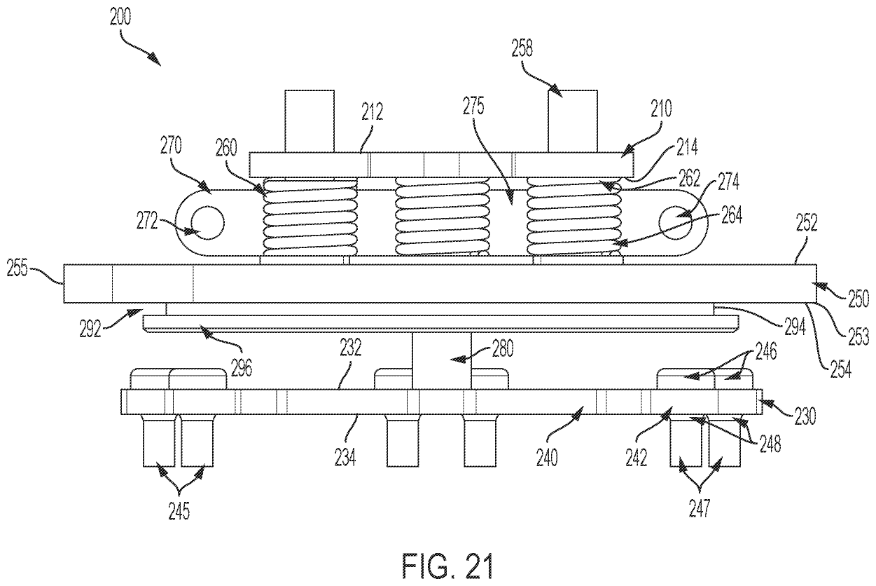

In step 902, a force may be applied to the inner handle 270, causing the inner intermediate plate 250 to move toward the inner top plate 210, thus compressing the inner spring 260 and increasing the gap between the inner intermediate plate 250 and the inner bottom plate 230. The inner flange spring device 200 with compressed springs 260 is shown in FIG. 21. The force may be applied until after the gap between the intermediate plate 250 and the inner bottom plate 230 exceeds the thickness of the flange of the component to which the inner flange spring device 200 may be intended to mask.

In step 904, the inner flange spring device 200 may be aligned with the drive shaft opening 72. The inner flange spring device 200 may be oriented such that the inner bottom plate bottom surface 134 may face the drive shaft opening 72 and the inner bottom plate bottom surface 134 may be parallel to the drive shaft opening 72. At least one inner arm end 242 may be aligned with at least one flange notch 75.

In step 906, the inner flange spring device 200 may move toward the drive shaft opening 72. The inner flange spring device 200 may be moved until the inner plug 245 is inserted through the drive shaft opening flange 74 past the drive shaft inner surface 77.

In step 908, the inner flange spring device 200 is rotated. The inner flange spring device 200 is rotated in a clockwise or counterclockwise direction such that the inner arm end 242 do not align with a flange notch 75.

In step 910, the force on the inner handle 270 may be released. As the force is released, the inner spring 270 may begin to decompress, forcing the inner intermediate plate 250 to move toward the inner bottom plate 230. The inner spring 270 may decompress until the inner flange spring device 200 clamps onto the drive shaft opening flange 74. Once inner spring 270 decompresses, the inner plug head 245 may contact the drive shaft inner surface 77, and the inner gasket 290 may contact the drive shaft outer surface 76. The clamping force may cause a leak tight seal between the inner gasket 290 and the drive shaft outer surface 76. The leak tight seal may prevent particle outside of the axle housing 20 from entering the inside of the axle housing 20 through the drive shaft opening 72.

In step 912, the axle housing 20 is painted. The axle housing 20 may be painted by spray painting, liquid painting, electrocoating, etc. During electrocoating, an electric current may be applied to the axle housing 20 to attract paint particles. However, the inner gasket 290 and each inner plug head 246 may decrease the electric current transferring to the inner flange spring device 200 itself due to the electrical insulation of the inner gasket 290 and each inner plug head 246, thus minimizing coatings of paint being applied to the surfaces of the outer flange spring device 100. Decreased coatings may result in a longer life of the outer flange spring device 100.

In step 914, a force may be applied to the inner handle 270, causing the inner intermediate plate 250 to move toward the inner top plate 210, thus decompressing the inner spring 260 and increasing the gap between the inner intermediate plate 250 and the inner bottom plate 230. The force may be applied until after the gap between the inner intermediate plate 250 and the inner bottom plate 230 exceeds the thickness of the drive shaft opening flange 74.

In step 916, the inner flange spring device 200 may be moved radially outward from the drive shaft opening flange 74 such that the drive shaft opening flange 74 may no longer be located between the inner intermediate plate 250 and the inner bottom plate 230.

In step 918, the force on the inner handle 270 may be released. As the force is released, the inner spring 270 may begin to decompress, forcing the inner intermediate plate 250 to move toward the inner bottom plate 230. The inner spring 270 may decompress until the inner plug head 246 comes in contact with the inner gasket 290, as shown in FIG. 18.

When installed on a component, the inner flange spring device 200 may cause a clamping force onto the component, such as on the drive shaft inner surface 77 and the first drive shaft outer surface 76, as shown in FIG. 3. The clamping force may cause leak tight seals between the inner gasket 290 and the drive shaft outer surface 76.

Whereas particular examples of this disclosure, such as an outer flange spring device 100 or an inner flange spring device 200, have been described above for purposes of illustration, it will be evident to those skilled in the art that numerous variations of the details of the present disclosure may be made without departing from what is defined in the appended claims.

1. A paint masking system comprising:
an axle housing structured and arranged to surround an axle of a vehicle, the axle housing comprising a connection comprising:
a first wheel opening comprising a first wheel opening flange;
a drive shaft opening comprising a drive shaft opening flange; and
a spring device structured and arranged for paint masking the axle housing, the spring device comprising:
a top plate opposite a bottom plate, wherein the top plate is secured to the bottom plate by at least one securing rod;
an intermediate plate located between the top plate and the bottom plate; and
at least one spring in contact with the intermediate plate and the top plate, wherein the at least one spring is structured and arranged to bias the intermediate plate toward the bottom plate, and the intermediate plate is structured and arranged to form a leak tight seal between the intermediate plate and an outer surface of the axle housing when the axle opening flange is clamped between the intermediate plate and the bottom plate.

2. The paint masking system of claim 1, wherein the spring device is an inner flange spring device and wherein the intermediate plate comprises a gasket secured to an intermediate plate bottom surface of the intermediate plate, wherein a gasket top surface contacts the intermediate plate bottom surface, and a gasket bottom surface opposite of the gasket top surface contacts an outer surface of the drive shaft opening flange.

3. The paint masking system of claim 2, wherein the intermediate plate comprises a handle structured and arranged to move the intermediate plate toward the top plate, compressing the at least one spring and increasing a gap between the intermediate plate and the bottom plate.

4. The paint masking system of claim 2, wherein the bottom plate further comprises at least one plug comprising a plug shaft extending from a plug head, wherein the plug head contacts an inner surface of the drive shaft opening flange opposite the outer surface of the drive shaft opening flange.

5. The paint masking system of claim 1, wherein the spring device is an outer flange spring device and wherein the intermediate plate comprises a gasket secured to an intermediate plate bottom surface of the intermediate plate, wherein a gasket top surface contacts the intermediate plate bottom surface and a gasket bottom surface opposite of the gasket top surface contacts an outer surface of the first wheel opening flange.

6. The paint masking system of claim 5, wherein the intermediate plate comprises a handle structured and arranged to move the intermediate plate toward the top plate, compressing the at least one spring and increasing a gap between the intermediate plate and the bottom plate.

7. The paint masking system of claim 5, wherein the bottom plate comprises at least one plug comprising a plug shaft extending from a plug head, wherein the at least one plug head contacts a first wheel fastener hole rear end of at least one first wheel fastener hole extending through the first wheel opening flange from a first wheel fastener hole front end adjacent the first wheel outer surface to the first wheel fastener hole rear end adjacent the first wheel inner surface.

8. The paint masking system of claim 7, wherein the plug head forms a leak tight seal between the plug head and the first wheel fastener hole rear end.

9. The paint masking system of claim 5, wherein the intermediate plate comprises at least one alignment pin extending toward the bottom plate, wherein the at least one alignment pin comprises an alignment pin shaft extending from an alignment pin head, wherein the alignment pin head is inserted into the first wheel fastener hole front end of the at least one-wheel fastener hole.

10. A spring device for paint masking a component comprising:
a top plate opposite a bottom plate, wherein the top plate is secured to the bottom plate by at least one securing rod;
an intermediate plate located between the top plate and the bottom plate; and
at least one spring in contact with the intermediate plate and the top plate, wherein the at least one spring is structured and arranged to bias the intermediate plate toward the bottom plate, wherein the intermediate plate is structured and arranged to form a leak tight seal between the intermediate plate and an outer surface of an opening of the component when the component is clamped between the intermediate plate and the bottom plate.

11. The spring device of claim 10, wherein the spring device is an inner flange spring device and wherein the intermediate plate comprises a gasket secured to an intermediate plate bottom surface of the intermediate plate, wherein a gasket top surface contacts the intermediate plate bottom surface, and a gasket bottom surface opposite of the gasket top surface is structured and arranged to contact an outer surface of the drive shaft opening flange.

12. The spring device of claim 11, wherein the intermediate plate comprises a handle structured and arranged to move the intermediate plate toward the top plate, compressing the at least one spring and increasing a gap between the intermediate plate and the bottom plate.

13. The spring device of claim 10, wherein the bottom plate further comprises at least one plug comprising a plug shaft extending from a plug head, wherein the plug head is structured and arranged to contact an inner surface of the drive shaft opening flange opposite the outer surface of the drive shaft opening flange.

14. The spring device of claim 10, wherein the spring device is an outer flange spring device and wherein the intermediate plate comprises a gasket secured to an intermediate plate bottom surface of the intermediate plate, wherein a gasket top surface contacts the intermediate plate bottom surface and a gasket bottom surface opposite of the gasket top surface is structured and arranged to contact an outer surface of the first wheel opening flange.

15. The spring device of claim 14, wherein the intermediate plate comprises a handle structured and arranged to move the intermediate plate toward the top plate, compressing the at least one spring and increasing a gap between the intermediate plate and the bottom plate.

16. The spring device of claim 14, wherein the bottom plate comprises at least one plug comprising a plug shaft extending from a plug head, wherein the at least one plug head contacts a first wheel fastener hole rear end of at least one first wheel fastener hole extending through the first wheel opening flange from a first wheel fastener hole front end adjacent the first wheel outer surface to the first wheel fastener hole rear end adjacent the first wheel inner surface.

17. The spring device of claim 16, wherein the plug head forms a leak tight seal between the plug head and the first wheel fastener hole rear end.

18. The spring device of claim 14, wherein the intermediate plate comprises at least one alignment pin extending toward the bottom plate, wherein the at least one alignment pin comprises an alignment pin shaft extending from an alignment pin head, wherein the alignment pin head is inserted into the first wheel fastener hole front end of the at least one-wheel fastener hole.

19. A method for paint masking an axle housing comprising:
installing a spring device onto the axle housing, the installation comprising:
compressing at least one spring of the spring device, wherein the at least one spring secures a top plate to an intermediate plate of the spring device, thus increasing a gap between the intermediate plate and a bottom plate of the spring device, wherein the intermediate plate is located between the top plate and the bottom plate, and wherein the bottom plate is secured to the top plate with at least one securing rod;
inserting the bottom plate into an axle opening of the axle housing such that the intermediate plate and the bottom plate are located opposite each other around an axle opening flange extending radially from the axle opening;
aligning a plug head of at least one plug of the bottom plate with the axle opening flange, wherein the plug head extends toward the intermediate plate; and
decreasing the gap by decompressing the at least one spring until the plug head contacts a bottom surface of the axle opening flange and the intermediate plate forms a leak tight connection with a top surface of the axle opening flange;
applying a coat of paint to the axle housing; and
removing the spring device from the axle housing, the removal comprising:
increasing the gap by compressing the at least one spring; and
removing the bottom plate from the axle opening.

20. The method of claim 19, wherein the spring device is an outer flange spring device and installation of the first wheel spring device comprises installation of the first wheel spring device on a first wheel opening flange.

21.-25. (canceled)
